(19) United States
(12) Patent Application Publication
(10) Pub. No.: US 2005/0237272 A1
(43) Pub. Date: Oct. 27, 2005

(54) Display device

(76) Inventors: Jessica Josephson, New York, NY (US); Shuji Inaba, Tokyo (JP); Rikayo Horimizu, Brooklyn, NY (US)

Correspondence Address: WINSTON & STRAWN LLP, 1700 K STREET, N.W., WASHINGTON, DC, 20006, US

(21) Appl. No.: 11/088,047

(22) Filed: Mar. 23, 2005

Related U.S. Application Data
(60) Provisional application No. 60/556,867, filed on Mar. 26, 2004.

(51) Int. Cl. G09G 3/14

(52) U.S. Cl. 345/46

(57) ABSTRACT

A device for displaying messages method of using the same, and machine readable program are provided. The device includes an elongate member having a proximal end, a distal end and defines a longitudinal axis. The device further includes a housing having a proximal end and a distal end, where the proximal end of the housing is coupled to the distal end of the elongate member. The housing includes a plurality of light-emitting devices disposed therein. The light emitting devices are oriented along the longitudinal axis. The device also includes a power source and a processor. The processor is operably coupled to the power source and light-emitting devices, wherein the processor is configured to cause the light emitting devices to emit light at predetermined intervals. The device causes a message to be displayed to an observer when the device is rotated about an axis of rotation at a predetermined rotational velocity.

### REFERENCE TO RELATED APPLICATIONS

The present application claims priority to Provisional U.S. Patent Application Ser. No. 60/566,867, filed Mar. 26, 2004.

### BACKGROUND OF THE INVENTION

1. Field of the Invention

The present invention relates to a device, method, and machine readable program for displaying messages and/or symbols. Particularly, the present invention is directed to a device for displaying text/based messages.

2. Description of Related Art

A variety of methods and systems are known for displaying messages for an observer. Certain devices include televisions, display panels, pixelated displays and the like.

U.S. Design Pat. No. 442,497 describes a device that, when rotated at a particular velocity, displays a message to an observer in a narrow annular strip defined by the end edge of the device when it is rotated. However, this device can only display messages at one discrete angular velocity, and can only display a message on a very small surface area as observed by an observer.

While such conventional methods and systems generally have been considered satisfactory for their intended purpose, it is desirable to have a display device that is capable of displaying a message on a large plane that can be viewed easily by an observer. It is also desirable to have a device that is inexpensive and can be used in a variety of areas and applications. There thus remains a continued need for an efficient and economic method and system for displaying messages to an observer.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

To achieve these and other advantages and in accordance with the purpose of the invention, as embodied and broadly described, the invention includes a device for displaying messages. The device includes an elongate member having a proximal end, a distal end and defines a longitudinal axis. The device further includes a housing having a proximal end and a distal end, where the proximal end of the housing is coupled to the distal end of the elongate member. The housing includes a plurality of light-emitting devices disposed therein. The light emitting devices are oriented along the longitudinal axis. The device also includes a power source and a processor. The processor is operably coupled to the power source and light-emitting devices, wherein the processor is configured to cause the light emitting devices to emit light at predetermined intervals. The device causes a message to be displayed to an observer when the device is rotated about an axis of rotation at a predetermined rotational velocity.

In accordance with a further aspect of the invention, the device can be configured to display a message at one or more predetermined rotational velocities. Moreover, the device can be configured to display a first message at a first rotational velocity, and a second, different message at a second rotational velocity. Additionally or alternatively, the device can be configured to display the same message over a plurality of different rotational velocities.

In accordance with another aspect of the invention, the device can further include a velocity detector operably connected to the processor, wherein the velocity detector is configured to detect the speed of the device. The velocity detector can directly measure the rotational velocity of the device. In accordance with one aspect of the invention, velocity detector comprises a rotational potentiometer operably coupled to the processor.

In accordance with another aspect of the invention, the device can further include a hub connected to the proximal end of the elongate member. If provided, the velocity detector can be located proximate to the hub. Additionally or alternatively, the velocity detector can directly measure the tangential velocity of the device.

In accordance with one aspect of the invention, the processor can be configured to compute rotational velocity using a directly measured tangential velocity. In accordance with this aspect of the invention, the processor can be configured to cause the light emitting elements to emit light in response to a rotational velocity measured using the velocity detector.

In accordance with still another aspect of the invention, the device can further include a handle mounted to the hub. Moreover, if a hub is provided, the hub and the handle can be integrally formed as a single piece. In accordance with a further aspect of the invention, the power source can be located within the handle.

In accordance with yet another aspect of the invention, the device can be configured to display a symbol. Moreover, the device is configured to display a text message. Additionally or alternatively, the device can be configured to display a geometric shape.

In accordance with still a further aspect of the invention, the power source can include a battery located within the handle. Additionally or alternatively, the power source can also include an electrical generator. In accordance with this aspect of the invention, electrical power is generated by the generator when the device is rotated. The generator can be proximate to the hub. Moreover, the generator can be configured to measure rotational velocity of device.

In accordance with a further aspect of the invention, a system is provided. The system can include a device as described above that is mounted to a wheel of a vehicle for displaying messages to observers. The device can be mounted to a vehicle used for public transportation, and used to display advertising messages. The hub can be mounted to the wheel of the vehicle.

The system can also include a device as described above integrated into other rotating objects such as a fan. The device can also include memory coupled to the processor. The device may optionally include a port operably coupled to the memory and the processor, wherein the port is configured to interface with an external device containing instructions for displaying a message in machine readable format. A computer can be operably coupled to the port by a direct cable connection or by a wireless connection.

The invention also includes a method for displaying messages. The method includes providing an elongate device as described above, operating a power source and a processor operably coupled to the power source and light-emitting devices to cause the light emitting devices to emit light at predetermined intervals, rotating the device about an axis of rotation wherein the longitudinal axis defines a radius of a substantially planar viewing plane, and displaying a message to an observer when the device is rotated at a predetermined rotational velocity.

In accordance with another aspect of the invention, a machine readable program is provided containing instructions in machine readable format for controlling a device to display messages, the device having an axis of rotation, an elongate body defining a longitudinal axis, a power source, a processor operably coupled to the power source, and a plurality of light emitting devices operably coupled to the processor and arranged along the longitudinal axis. The program includes means for operating the processor to cause the light emitting devices to display a message to an observer in a substantially planar viewing plane when the device is rotated at a predetermined rotational velocity, the viewing plane defined by rotating the device about the axis of rotation.

It is to be understood that both the foregoing general description and the following detailed description are exemplary and are intended to provide further explanation of the invention claimed.

The accompanying drawings, which are incorporated in and constitute part of this specification, are included to illustrate and provide a further understanding of the method and system of the invention. Together with the description, the drawing serves to explain the principles of the invention.

### BRIEF DESCRIPTION OF THE DRAWINGS

FIG. 1 is a schematic representation of the display device in accordance with the invention.

FIG. 2 is an exploded view of a selected portion of a display device in accordance with the invention.

FIG. 3 is a further exploded view of a selected portion of a display device in accordance with the invention depicted in FIG. 2.

FIG. 4 is an exploded view of a selected portion of a display device in accordance with the invention.

FIG. 5 is a view of a selected portion of a display device in accordance with the invention.

FIG. 6 is a view of an alternative embodiment of a display device in accordance with the invention.

FIG. 7 is a view of an additional alternative embodiment of a display device in accordance with the invention.

FIG. 8 is a view of a specific exemplary embodiment of a display device in accordance with the invention.

FIG. 9 is a schematic representation of a method of displaying a character using a display device in accordance with the invention.

FIGS. 10-13 are examples of characters displayed using a display device in accordance with the invention.

FIG. 14 is a view of a selected portion of a display device in accordance with the invention.

### DETAILED DESCRIPTION OF THE PREFERRED EMBODIMENT

Reference will now be made in detail to the present preferred embodiments of the invention, an example of which is illustrated in the accompanying drawings. The method and corresponding steps of the invention will be described in conjunction with the detailed description of the system.

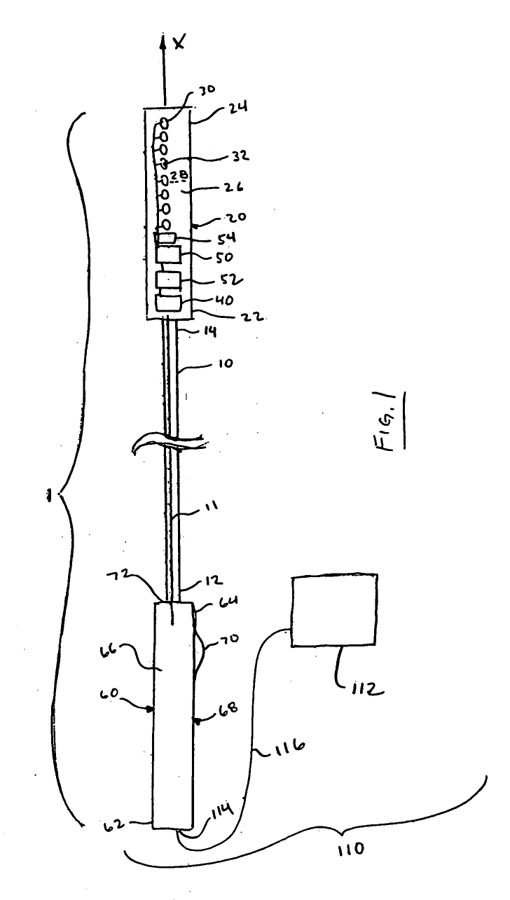

The devices, methods, systems and machine readable programs presented herein may be used for displaying graphic representations. The present invention is particularly suited for displaying text messages and/or symbols. For purpose of explanation and illustration, and not limitation, an exemplary embodiment of a device in accordance with the invention is shown in FIG. 1 and is designated generally by reference character 1.

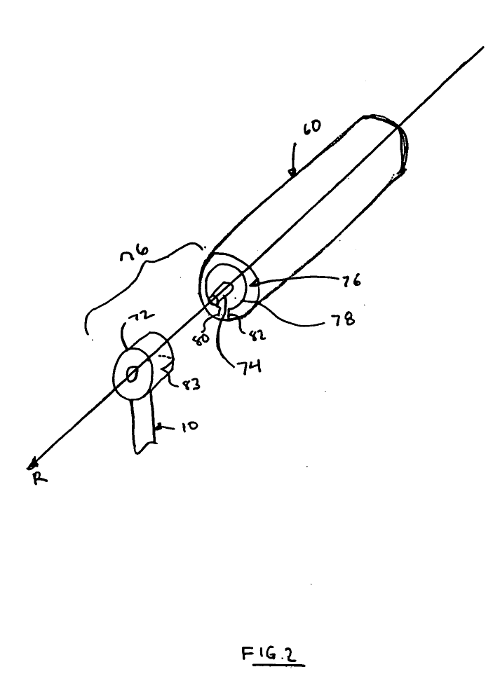

As shown in FIG. 1, the device 1 generally can include an elongate member 10, a housing 20 including a plurality of light-emitting devices 32, a power source 40, a processor 50 and, optionally, a handle 60. Additional embodiments or portions thereof are shown in FIGS. 2-8 and 14 for purpose of illustration and not limitation.

Device 1 can be used for displaying messages. In accordance with one embodiment of the invention, a user grabs the handle by its proximal end, lifts it overhead, or at arm's length in front of the body, and swings or “twirls” it (i.e., rotates it about the handle) until the device is rotating fast enough so that the light emitting devices spell out a word, message or image to an observer. The device can be a part of a system including, for example, an external computer, or it can be used independently. Different messages can be downloaded from a computer or other terminal, but the device 1 is not limited as to what can be communicated.

Display device 1 can be used for many practical purposes. A computer display or screen display is very large and cumbersome. A portable device that a person can put in a pocket can be far more useful than a large monitor. Device 1 is suitable for use, for example, as a children's toy that could be used to help children learn how to spell. Device 1 is also suitable for use as an art, design and advertising medium. For example, a client could embed a permanent message in device 1 and give it to patrons at a store or a sporting event to display a message when used.

In accordance with the invention, the device includes an elongate member having a proximal end mounted to the hub and a distal end and defining a longitudinal axis.

For purposes of illustration and not limitation, the elongate member 10 is schematically depicted in FIG. 1. Elongate member 10 is generally a flexible elongate cylindrical member. Elongate member 10 has a proximal end 12 optionally mounted to a hub 72 and a distal end 14, and defines a longitudinal axis X. Hub 72 need not provided and/or device 1 can be gripped by proximal end 12 of elongate member 10.

Elongate member 10 is preferably made at least in part of a plastic material such as a thermoplastic or other suitable material. Elongate member 10 can be provided with a power source 40 for illuminating the light emitting devices 32 embedded in housing 20, discussed in detail below. As depicted in FIG. 1, power source 40 is located in housing 20. Additionally or alternatively, elongate member 10 can include conductive elements 11 for routing electrical power from a handle 60 or other mounting point, if provided (discussed below).

In further accordance with the invention, the device includes a housing configured to hold a plurality of light emitting devices.

For purposes of illustration and not limitation, the housing 20 is schematically depicted in FIG. 1. Housing 20 generally has a proximal end 22 and a distal end 24, wherein the proximal end 22 of the housing 20 is coupled to the distal end 14 of the elongate member 10. Housing can include a wall portion 26 defining an interior chamber 28. Housing can also define one or more openings 30 for a plurality of light emitting devices 32, discussed in detail below.

Housing 20 is preferably molded from a plastic material, and can be coupled to elongate member 10 in a number of ways. Housing 20 can be integrally formed with elongate member 10, particularly where they are molded from a plastic material that is sufficiently resilient to permit the elongate member 10 to flex when the device is used. The housing 20 can also be formed separately from the elongate member 10, and be attached thereto by a threaded or snap fit connection, or by adhesive or other bond or weld. If desired, housing 20 may be attached to elongate member 10 by a rotatable coupling. Such a coupling may be accomplished by a snap and/or forced fit.

In further accordance with the invention, the device includes a plurality of light-emitting devices oriented along the longitudinal axis and mounted in the housing.

For purposes of illustration and not limitation, light emitting devices 32 are schematically depicted in FIGS. 1, 5, 6 and 8. Light-emitting devices 32 are operably coupled to a processor 50 and power source 40 discussed in detail below. Light-emitting devices 32 can be individually mounted in pre-formed recesses 30 in housing 20, or can be mounted or formed on a flexible circuit board or substrate (not shown), wherein the board or substrate is provided with conductive elements thereon to electrically connect light-emitting devices directly or indirectly with processor 50 and power source 40. All that is required is that light-emitting devices be able to define discrete areas from which light is emitted.

Light-emitting devices 32 are depicted in FIG. 1 as eight light-emitting diodes “LED's,” aligned in a longitudinal direction of the housing 20. However, other various devices and numbers thereof may be used as light-emitting devices 32. For example, light emitting devices 32 may simply be small incandescent light bulbs having a conventional filament. Where a higher amount of light output is necessary other types of lighting elements (e.g., halogen) lights may be used where appropriate for the application. Light emitting devices may also be formed in a manner similar to an active matrix display panel using thin-film transistors (“TFTs”). In accordance with this variation, a multi-pixelated elongate display panel may be provided including dozens or hundreds of TFTs, as may be appropriate depending on the application. This may be connected with processor in a conventional manner as is known in the art. Organic light-emitting diodes may also be employed. Moreover, flexible polymer screens can also be employed similar to the “Polymer Vision”™ display technology available from Philips corporation, which uses thin-film transistors (“TFTs”) mounted on a polymeric material instead of glass, and uses “eInk” ™ a system using half black/half white capsules that uses an electrical charge to change the capsule's orientation. Other polymeric films capable of acting as a display medium are also within the scope of the invention.

In further accordance with the invention, the device also includes a power source operably coupled to the plurality of light-emitting devices.

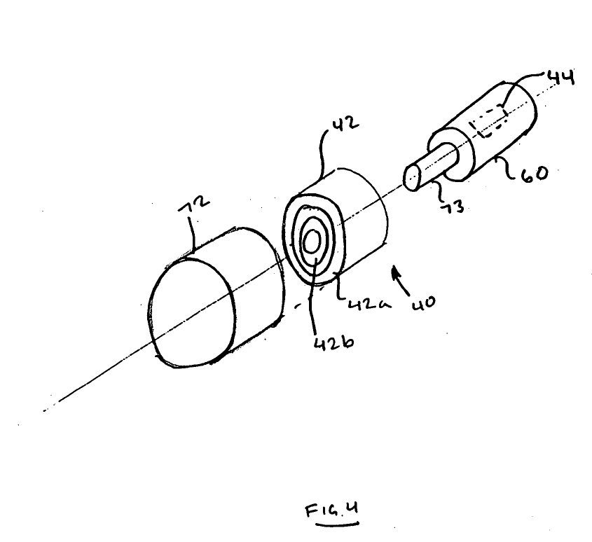

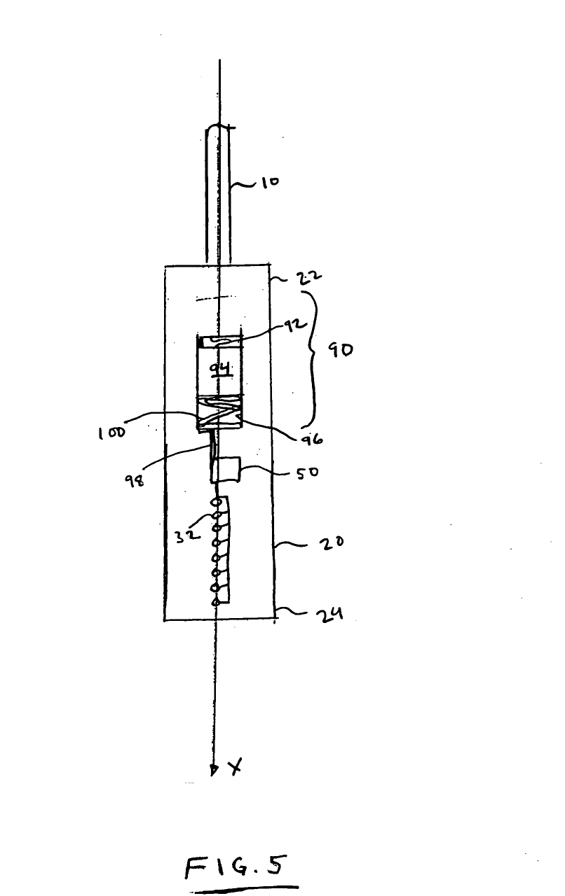

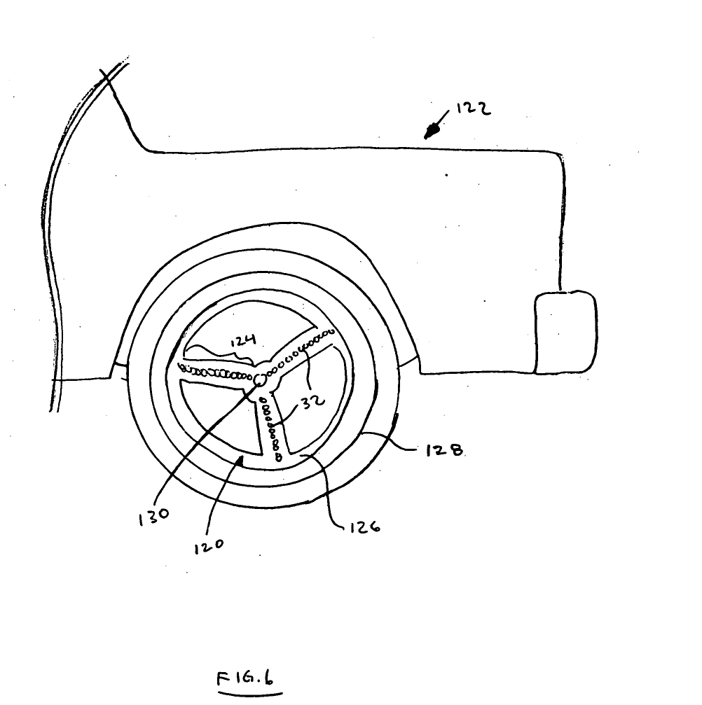

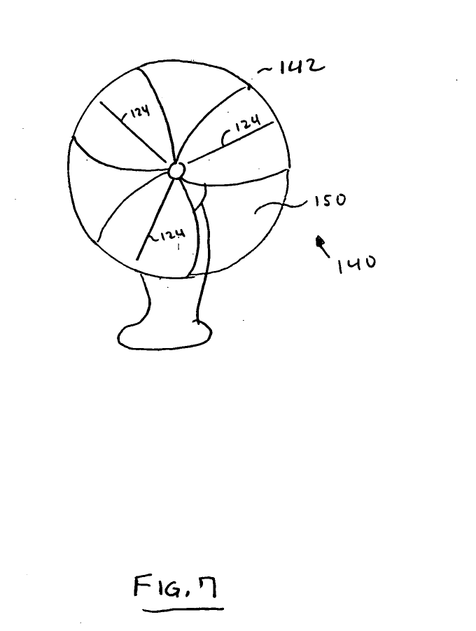

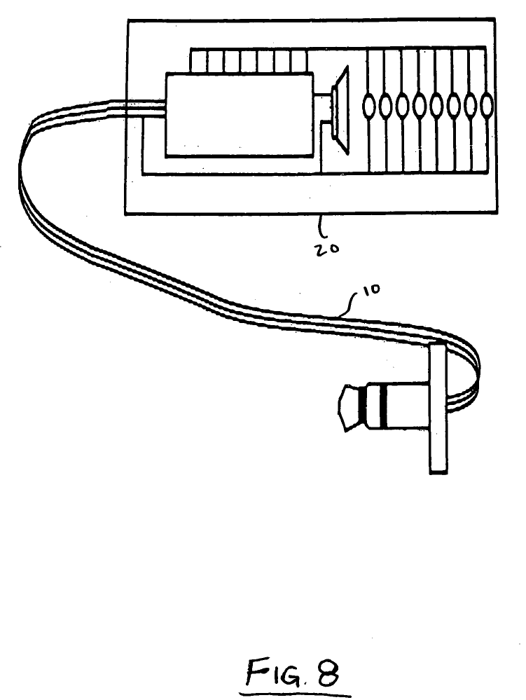

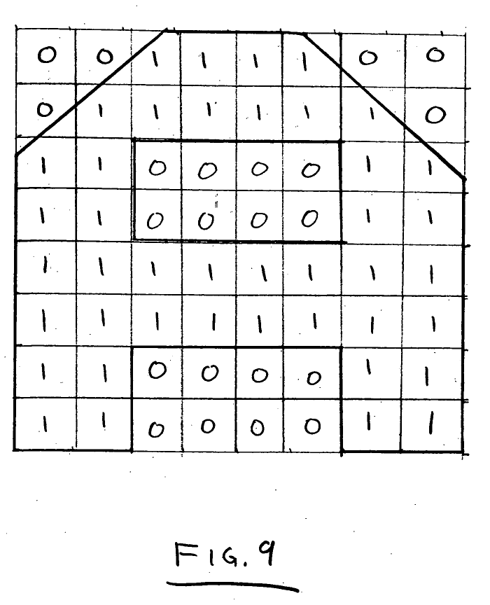

For purposes of illustration and not limitation, power source 40 is schematically depicted in FIGS. 1 and 4. Power source 40 is preferably a rechargeable power source, such as a nickel metal hydride or lithium ion battery. Power source can also take the form of an alternating-current generator 42, that generates power when the device 1 is rotated, as discussed below.

Power source 40 can be located inside housing 20, elongate member 10, or handle 60 (discussed below). Where device 1 is a part of a larger system, such as a vehicle or fan, as discussed below, the power source 40 can be located elsewhere within the system, and electrically connected to device either directly or via radio frequency/inductively coupled power transmission.

In further accordance with the invention, the device includes a processor operably coupled to the power source and light-emitting devices.

For purposes of illustration and not limitation, processor 50 is schematically depicted in FIG. 1. Processor 50 can be any microprocessor that can be programmed to display messages or graphic representation in accordance with the invention. A suitable processor for certain applications can be a PIC 16F876 microchip, manufactured by Microchip Technology, Inc. of Chandler, Ariz. (website found at www.microchip.com).

Preferably, the processor 50 either includes or is operably coupled to a memory cache 52. In this manner, graphic representations can be stored in memory cache 52 for later display by device 1. Processor 50 is also provided with a timer 54 in order to enable it to activate the light-emitting devices 32 at predetermined time intervals to display a message or graphic representation to an observer.

Processor 50 can be programmed to illuminate light emitting devices 32 in a number of ways. As can be seen, light emitting devices 32 are spaced radially from one another, such that a light emitting device 32 spaced further from the center of rotation of device 1 than another light emitting device will be traveling at a slightly faster tangential velocity. Under certain circumstances, such as where light emitting devices 32 have a large distance between them in a radial direction, this tangential velocity difference can affect the quality of the image displayed by the user by causing the “top” of the letters to “spread out.” Thus, it may be desirable under certain circumstances to illuminate more inwardly located light emitting devices 32 for a shorter time than ones located radially outward away from the center of rotation. In accordance with a handheld embodiment of device 1, the radial distance between adjacent pixels quite is small relative to the radial distance between the center of rotation of device 1 and the light emitting devices 32. As such, it is not necessary to account for the radial distance (and varying tangential velocity) between adjacent light-emitting devices, 32. In other applications, however, where device 1 is very large, this factor can be accounted for to improve image quality.

As with power source 40, processor 50 and memory cache 52 can be located in housing 20, elongate member 10 or handle 60 (described below). For ease of manufacturing, processor 50 and memory cache 52 are preferably located within housing 20.

In further accordance with the invention, the device can also include a handle for gripping by a user.

For purposes of illustration and not limitation, handle 60 is schematically depicted in FIG. 1-4. In the embodiment depicted in FIG. 1, handle 60 has a proximal end 62, a distal end 64 and a body 66 having an outside surface 68. The distal end 64 of handle 60 is connected to the proximal end 12 of elongate member 10.

Like housing 20 and elongate member 10, handle 60 can be formed of plastic by way of, for example, injection molding. In accordance with one aspect of the invention, housing 20, elongate member 10 and handle 60 are injection molded from a single piece of plastic material. As described above, handle 60 can be configured to hold power source 40, processor 50 and memory cache 52.

The outside surface 68 of handle 60 can be shaped ergonomically for ease of gripping by a user, and can be provided with one or more gripping portions 70. Gripping portions 70 may be formed integrally with the handle 60 during manufacturing when molded, or can be applied later. If a separately applied component, gripping portion 70 is preferably formed of a soft rubber material that can enhance a user's grip.

In further accordance with the invention, the device can include a hub defining an axis of rotation for device 1.

For purposes of illustration and not limitation, the hub 72 is schematically depicted in FIGS. 2-4. Hub 72 is generally circular in shape, and can be used to connect elongate member 10 to handle 60. When so used, in combination with spindle 73, hub 72 defines a joint or bearing surface 74 that can permit rotation between elongate member 10 and handle 60, about an axis of rotation R to facilitate use of the device. Hub 72 can be integrally formed with elongate member 10. Hub 72 can be mounted to handle 60, or can be mounted to a larger system, such as a stationary mounting, or even a wheel or wheel cover of a vehicle, discussed in detail below. Hub 72 can be formed of any combination of metal, plastic, or rubber components or the like.

In accordance with a further aspect of the invention, the device 1 can be provided with a speed detector to sense the speed that the device is moving at when being used.

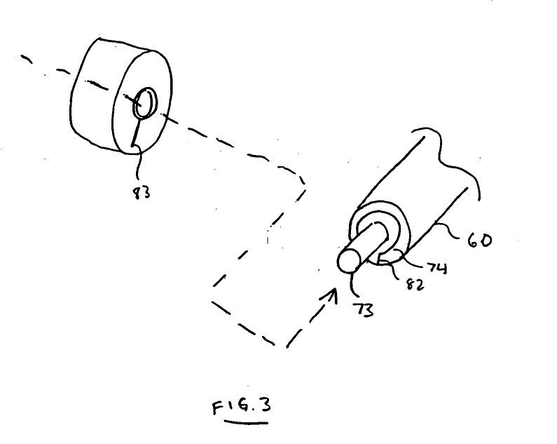

For purposes of illustration and not limitation, as depicted in FIGS. 2 and 3, speed detector 76 is depicted herein as a rotational potentiometer 78 mounted to handle 60 and hub 72. The potential difference is measured between electrical leads 80, 82 and 83 connected to the potentiometer 78 and hub 72 respectively, to determine the angular position of elongate member 10 with respect to potentiometer 78. Electrical leads 80, 82 and 83 are operably connected to processor 50. In accordance with this aspect of this invention, processor 50 and timer 54 are configured to measure the rotational speed of the device 1 while in use by continuously measuring the potential difference across the potentiometer to determine the speed of angular displacement, or rotational speed, of device 1. In this manner it is possible for the sequencing of the light-emitting devices to change as the rotational speed of the device changes. This can facilitate displaying a message to an observer, since the device can display a recognizable image at two or more discrete rotational velocities, or a range of rotational velocities.

A variety of other devices can be provided to measure the angular velocity of device 1 when it is rotated. Instead of potentiometer 78, a magnet and magnet detector (not shown) can be mounted to handle 60 and hub 72 respectively (or vice-versa).

Similarly, a reflective surface 75 can be provided on handle 60 or hub 72 (or elongate member 10) and an infrared (“IR”)-LED module 77 can be provided on hub 72 or handle 60, respectively, to measure the frequency of rotation. As depicted in FIG. 14, IR signal is launched from transmit portion 77a of module 77, and is reflected by reflective surface 75 of elongate member 10 when elongate member 10 passes through the path 77c of the IR transmit beam. Reflected beam 77d then passes to receive portion 77b of module 77. In response to receiving signal 77d, module 77 provides an electrical signal to processor 50 to allow processor 50 to calculate the rotational velocity of elongate member 10.

As with potentiometer 78, the magnet detector or IR-LED module can be interfaced with processor 50 to properly time the display of words or symbols.

When a speed detector is not provided, the device 1 can be configured to display a message when rotated at a predetermined angular velocity, such that if the user spins the device 1 too quickly or too slow, the message will not be legible. Alternatively, the device 1 can be programmed to activate the light-emitting devices in a manner that a first message is displayed at a first rotational speed, and a second message is displayed at a second rotational speed. The messages can be the same, or can be different. Device 1 can also be programmed such that the message appears to “move” in a radial direction while the device is being twirled.

In further accordance with the invention, the device can also be provided with a generator to generate electrical power to operate the device.

For purposes of illustration and not limitation, as embodied herein, an alternating-current generator 42 can be provided (see FIG. 4) that generates alternating current when the device 1 is rotated during use about the axis of rotation. Generator has an outer rotor portion 42a attached to hub 72 and an inner stator portion 42b attached to spindle 73. Thus, when the device 1 is rotated, the rotor rotates with respect to the stator, thereby generating electrical current which is provided to the processor and LEDs via electrical leads (not shown). Generator 42 can provide all or a portion of the power for device 1, or may be provided in addition to a battery source 44, and be configured to recharge the battery via a recharging circuit (not shown). In accordance with this aspect of the invention, generator 42 is preferably formed as a part of hub 72. Thus, when the device 1 is rotated faster about axis of rotation R, more electrical power can be produced than when the device is rotated more slowly, which can result in a brighter image conveyed to an observer.

Moreover, the electrical signal output of generator 42 can be measured to measure the rotational speed of device 1. This can be accomplished if processor is configured to measure the sinusoidal variation in voltage of the generator over time. One full rotation of device 1 will result in a complete cycle (e.g., a voltage trace over time resembling a sine wave of period 2π). Thus, processor 50 can accomplish this time-varying voltage measurement via correlation with the output of timer 54 (or can be provided with its own timer) to measure the rotational speed of device 1 while in use.

In certain applications, it may be necessary or desirable to provide a step-up or step-down in gearing between hub 72 and generator 42. An example of this could be where it is desirable to have the generator 42 to spin at a different speed than device, such as where the speed at which device 1 is rotated does not provide electrical power at a sufficient frequency to supply continuous power to light emitting devices (particularly where no power source 40 besides generator 42 is provided). Such gearing can be in the form of a planetary gear arrangement (not shown), which provides the benefit of having the hub 72 and generator 42 and gearing in alignment along the axis of rotation R. Other possibilities are contemplated however. A drive gear (not shown) attached to hub 72 can interface with a gear on generator (not shown) via an idler gear (not shown), where the idler gear is offset from the axis of rotation R of device 1.

Instead of gearing, it would also be possible to provide a circuit including a capacitor (not shown) where an additional power source 44 (e.g., a battery) is not provided to even out the power flow. In this manner, the capacitor 58 would maintain an electrical charge that could be used to keep light emitting devices 32 activated while the device is being rotated, and to power processor 50.

In further accordance with the invention, the device can be provided with a switch to turn the device on and off.

For purposes of illustration and not limitation, as embodied herein and as depicted in FIG. 5, device 1 is provided with a switch 90 that permits electrical power to flow from power source 40 to processor 50, accompanying circuitry and light-emitting devices 32. Such a switch 90 can advantageously be provided, particularly where device 1 includes only a battery 44 as a power source 40 to keep the battery 44 from running out of power during periods of non-use of the device. Switch 90 can be a conventional flip, slide or toggle switch.

Switch 90 can also be configured to close a circuit only when device 1 is being rotated. Such a switch 90 can be similar to that depicted in FIG. 5, that includes a proximal conductor 92 attached to a weight or mass 94 configured to slide in a rail 96, and a distal conductor 98 attached to a stationary point for example, attached to housing 20. Weight 94, and hence, proximal conductor 92 are biased from distal conductor 98 by an elastic member or spring 100 in a direction toward elongate member 10 and away from distal end 24 of housing 20. When device 1 is rotated, weight 94 is urged toward the distal end 24 of housing 20 until proximal conductor 92 and distal conductor 98 connect, thereby closing an electrical circuit to permit light-emitting devices 32 to activate. Proximal conductor 92 may be a flexible wire, or a conductive strip that mass 94 slides against to create electrical contact.

Switch 90 can also be provided in a variety of other forms. For example, switch 90 can be provided as a mercury switch or other switch that is capable of turning on when device 1 is rotated. Switch 90 can also be an electronic switch that is programmed to turn off after periods of non-use (e.g., 10 seconds) of device 1.

In further accordance with the invention, a device can be provided as described above further indicating an acoustic emitter. In accordance with one embodiment of the method of the invention, a speaker (not shown) is provided to emit one or more sounds. A speaker may be provided to emit an indicator sound (e.g., a “beep”) during use of device 1, described more fully below in conjunction with the method of the invention. Sounds may also be emitted by device 1 as a supplement to the visual display that can be produced with device 1. Any sounds can be programmed to be emitted by into device 1. For example, at sporting events, cheers and/or theme music can be emitted by device 1. Other sounds (such as warnings, etc.) are, of course, also possible. These sounds can be carried permanently on onboard memory or can be programmed into device 1 via cable or wireless connection, even when device 1 is being used. The emission of sounds can be activated when the unit is turned on using switch 90, described above.

In further accordance with the invention, a system is provided including a device for displaying messages as disclosed herein and an additional component such as an external input device.

For purposes of illustration and not limitation, system 110 is schematically depicted in FIG. 1. System 110 can take any one of a number of forms.

For example, system 110 can include device 1, and an external computer 112 (see FIG. 1). In accordance with this aspect of the invention, a port 114 on handle 60 can be connected to computer 112 via a cable or wireless (e.g., infrared) connection 116 to transmit programming instructions to device 1. Such programming instructions can include, for example, instructions for displaying messages and/or graphic representations on device 1 when in use, instructions for monitoring the output of generator 42, and the like. Where the power source 40 onboard device 1 is a rechargeable battery, port 114 can also be configured to provide electrical power to device 1.

Moreover, device 1 can be configured to be permanently attached to computer 112. Such applications can include, for example, a permanent display in a store window or at a trade show, and the like. In accordance with this aspect of the invention, it may be desirable to mount device 1 to a rotatable mount that includes hub 72 and a motor 118 to permit motor 118 to rotate device 1 so that an operator need not be present.

In accordance with a further aspect of the invention, device 1 can be integrated into a wheel or wheel cover of a vehicle.

For purposes of illustration and not limitation, as embodied herein and as depicted in FIG. 6, device 1 is presented in a form integrated into a wheel cover 120 of a vehicle 122. One or more rows 124 of light-emitting devices 32 can be provided, as desired that are spaced from one another in a radial direction defined by the wheel cover 120 as depicted in FIG. 6. Such devices can be provided for decorative effect on a vehicle such as an automobile, truck, motorcycle or bicycle. Device 1 can also be used to provide advertising space on vehicles such as public buses, taxi cabs and the like.

Device 1 can also be integrated into different types or portion of wheels, including wheel covers as described above, and the like. Device 1 can be incorporated into decorative rotating wheel covers as well. Decorative rotating wheel covers are well-known in the art, and include a rotatable wheel cover portion 126 rotatably mounted to a stationary wheel rim 128. When a vehicle is driven, angular momentum is transferred from the wheel rim 128 to the rotatable wheel cover portion 126 via a bearing 130. When the vehicle stops (e.g., in traffic or to park), the rotatable wheel cover portion 126 continues to spin for a period of time due to the angular momentum it has accumulated while driving. Thus, even when the vehicle 122 is stationary, if the rotatable wheel cover portion 126 is provided with device 1, it can continue to display messages, even when the vehicle is not moving.

Device 1 can also be integrated into a fan 140, as depicted in FIG. 7. When the fan 140 is used, light-emitting devices 32 disposed radially in strips 124 along one or more fan blades 142 are activated to display messages to a user. The fan 140 can be configured to display the same, or different messages, at different fan speeds. Moreover, fan 140 can be programmed to display different messages and/or emit different sounds using a remote control (not shown). In accordance with this aspect of the invention, fan 140 can be provided with an infrared (“IR”) receiver.

Device 1 can also be incorporated into a main and/or tail rotor of a helicopter. Such a combination can be particularly useful in police helicopters to identify them at night to observers on the ground, to display corporate logos or messages on corporate helicopters or military information on military helicopters or other similar applications.

Device 1 can also be incorporated into a baton for use in parades, sporting events, and the like. The baton may be programmed to emit light and/or sound, as desired. The baton can be configured to switch on when used, as generally described above.

Such a baton can be used to display images rather than text due to the relatively short length of a baton. A plurality of batons can also be provided to a plurality of users to display the same, or different information. The plurality of batons can be programmed via infrared (“IR”) link to display images and emit sounds as desired from a central location. Such images and sounds can be displayed synchronously among the plurality of users.

Device 1 can also be used on a much larger scale. A very wide strip of rows of light emitting devices 32 can be arranged and towed behind an airplane or other airborne device (e.g., blimp) for displaying messages (preferably at night). As such, a strip towed behind a plane laterally (using a tether) can be configured to spell out messages as the plane moves. Instead of conventional light emitting devices, a flexible polymer screen can also be employed with light-emitting devices 32 mounted thereon. Moreover, as indicated above, such a visual display can also be accompanied by projecting sound from speakers in the airborne device.

In further accordance with the invention, a method is provided for displaying messages using a device as described herein. The method includes providing an elongate device as described herein above, operating a power source and a processor operably coupled to the power source and light-emitting devices to cause the light emitting devices to emit light at predetermined intervals rotating the device about an axis of rotation wherein the longitudinal axis defines a radius of a substantially planar viewing plane and displaying a message to an observer when the device is rotated at a predetermined rotational velocity. Any of the devices described hereinabove can be used to practice this method. An illustration of the viewing plane is represented by plane 150 in FIG. 7.

In accordance with one embodiment of the method of the invention, device 1 is rotated by a user about an axis of rotation until device 1 begins to emit an audible indication (e.g., a “beep”) during a cycle or regular time interval (e.g., once per second). The user can rotate the device such that the “beep” is emitted at the same point of the rotation (e.g., at the top of the rotation). The light emitting devices 32 can be programmed to display an entire word or phrase during the cycle one or more times. Timing the audible “beep” with the physical position of device 1 and the sequencing of light emitting devices 32 permits a message to be displayed in the same physical location of the viewing plane 150 each cycle, thereby facilitating display of a message to an observer.

In further accordance of the method of the invention, the device 1 can be configured to emit light at more than one wavelength, thus permitting the emission of light in one or more colors.

In further accordance with the invention, a machine readable program containing instructions in machine readable format for controlling a device as described herein is provided. The program includes means for operating the processor to cause the light emitting devices to display a message to an observer in a substantially planar viewing plane when the device is rotated at a predetermined rotational velocity, the viewing plane defined by rotating the device about the axis of rotation. The machine readable program may be selectively permanently stored in memory in device 1, for example, in EEPROM memory. The instructions may additionally or alternatively be stored on a computer separate from device 1 and transferred thereto selectively by way of a direct cable or wireless connection.

An example of a device made in accordance with the teachings herein is described in the Example below.

### EXAMPLE I

An exemplary embodiment of device 1 is depicted in FIG. 8. Device 1 includes eight LEDs and a PIC 16F876 microchip on the end of the rope, attached to a narrow, hard board on which the row of LEDs in displayed. All the data of the English alphabet, including numbers, is programmed into the microchip. Each time an LED message is required by the action of the rope, the chip sends out a character. One character consists of 8 dots by 8 dots of the matrix, and the LEDs show one row of the 8 dots one line at a time, moving from left to right. The timing of each blink is one microsecond. As the rope spins, the position of the LEDs move, and the observer logs the picture of the blinks in his/her memory. From this process, one character at a time, a word or message is formed, as if it were a continuous image. A beep sounds at the correct intervals to indicate to the user that they are rotating the device at the right speed, to facilitate display of the message.

### EXAMPLE II

### Making a Letter

Using the device described in Example I above, all letters and symbols to be used were stored in EEPROM, in which data won't vanish when it turn off. When a letter is displayed using the LEDs, the data of the letter is called from the address in EEPROM.

In the exemplary device of this Example, one letter is represented by 8×8 bits of matrix as it is showed in FIG. 9. For example, for the letter “A”, the data is stored in 0x1108 to 0x1115 as follows:
#rom 0x1108={0xFC, 0xFE, 0x33, 0x33, 0x33, 0x33, 0xFE, 0xFC}//A 65
   As depicted above, the numbers in the { } show each vertical lines of the matrix. For example, 0x1108 represents the address in 0xFC(=11111100 in binary). As depicted herein, each number (“1” or “0”) represents binary data wherein “1” is an instruction to switch an LED on and “0” is off. The string “11111100” represents instructions to determine which LEDs will activate in device 1 at a given point in time. In other words, one column in the 8×8 matrix is represented at a particular point in time by the 8 LEDs on the rope. Immediately after this first column is displayed using the first data string, the second column is displayed using a second eight digit data string, etc. until all eight columns have been displayed as device 1 is being rotated about its axis of rotation.

### EXAMPLE III

### Storage of Alphabet

Data for the alphabet was stored in memory of the device illustrated in these examples in the following manner:

| | |
|---|---|
| 032 | #rom 0x1000 = {0x00 |
| !33 | #rom 0x1008 = {0xC0 |
| /″34 | #rom 0x1020 = {0xFF |
| #35 | #rom 0x1018 = {0xFF |
| /36 | #rom 0x100f = {0xFF |
| %37 | #rom 0x1028 = {0xFF |
| &38 | #rom 0x1030 = {0xFF |
| 39 | #rom 0x1038 = {0xFF |
| (40 | #rom 0x1040 = {0xFF |
| )41 | #rom 0x1048 = {0xFF |
| *42 | #rom 0x1050 = {0xFF |
| +43 | #rom 0x1058 = {0xFF |
| ,44 | #rom 0x1060 = {0xFF |
| 45 | #rom 0x1068 = {0xFF |
| 46 | #rom 0x1070 = {0xFF |
| 47 | #rom 0x1078 = {0xFF |
| 0 48 | #rom 0x1080 = {0x00 |
| 1 49 | #rom 0x1088 = {0xC6 |
| 2 50 | #rom 0x1090 = {0x66 |
| 3 51 | #rom 0x1098 = {0x38 |
| 4 52 | #rom 0x10A0 = {0x6F |
| 5 53 | #rom 0x10A8 = {0x7E |
| 6 54 | #rom 0x10B0 = {0x07 |
| 7 55 | #rom 0x10B8 = {0x66 |
| 8 56 | #rom 0x10C0 = {0x4E |
| 9 57 | #rom 0x10C8 = {0x7E |
| 58 | #rom 0x10D0 = {0xFF |
| 59 | #rom 0x10D8 = {0xFF |
| 60 | #rom 0x10E0 = {0xFF |
| 61 | #rom 0x10E8 = {0xFF |
| 62 | #rom 0x10F0 = {0xFF |
| LOVE63 | #rom 0x10F8 = {0x1E |
| @64 | #rom 0x1100 = {0xFF |
| A 65 | #rom 0x1108 = {0xFC |
| B 66 | #rom 0x1110 = {0xFF |
| C 67 | #rom 0x1118 = {0x7E |
| D 68 | #rom 0x1120 = {0xFF |
| E 69 | #rom 0x1128 = {0xFF |
| F 70 | #rom 0x1130 = {0xFF |
| G 71 | #rom 0x1138 = {0x7E |
| H 72 | #rom 0x1140 = {0xFF |
| I 73 | #rom 0x1148 = {0x00 |
| J 74 | #rom 0x1150 = {0x60 |
| K 75 | #rom 0x1158 = {0xFF |
| L 76 | #rom 0x1160 = {0xFF |
| M 77 | #rom 0x1168 = {0xFF |
| N 78 | #rom 0x1170 = {0xFF |
| O 79 | #rom 0x1178 = {0x7E |
| P 80 | #rom 0x1180 = {0xFF |
| Q 81 | #rom 0x1188 = {0x7E |
| R 82 | #rom 0x1190 = {0xFF |
| /S 83 | #rom 0x1198 = {0x46 |
| T 84 | #rom 0x11A0 = {0x01 |
| U 85 | #rom 0x11A8 = {0x7F |
| V 86 | #rom 0x11B0 = {0x07 |
| W 87 | #rom 0x11B8 = {0x7F |
| X 88 | #rom 0x11C0 = {0xC3 |
| Y 89 | #rom 0x11C8 = {0x07 |
| Z 90 | #rom 0x11D0 = {0xC1 |
| 032 | #rom 0x1000 = {0x00 |

### EXAMPLE IV

### Display of Selected Characters

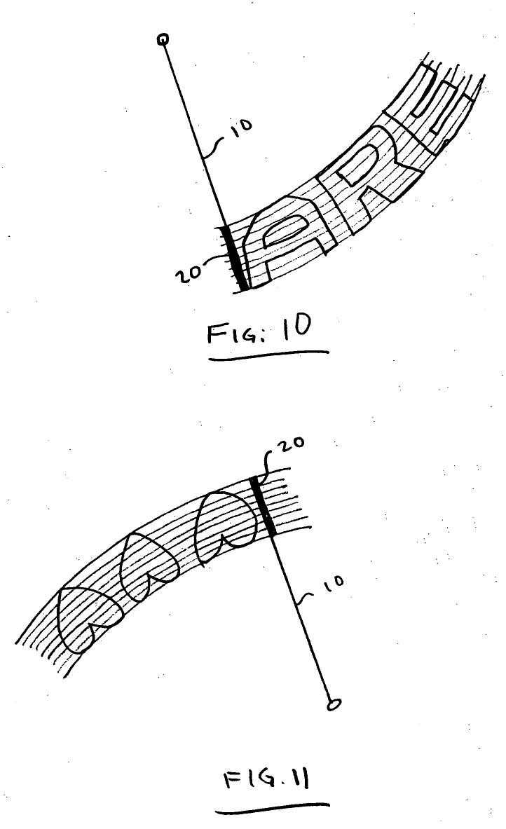

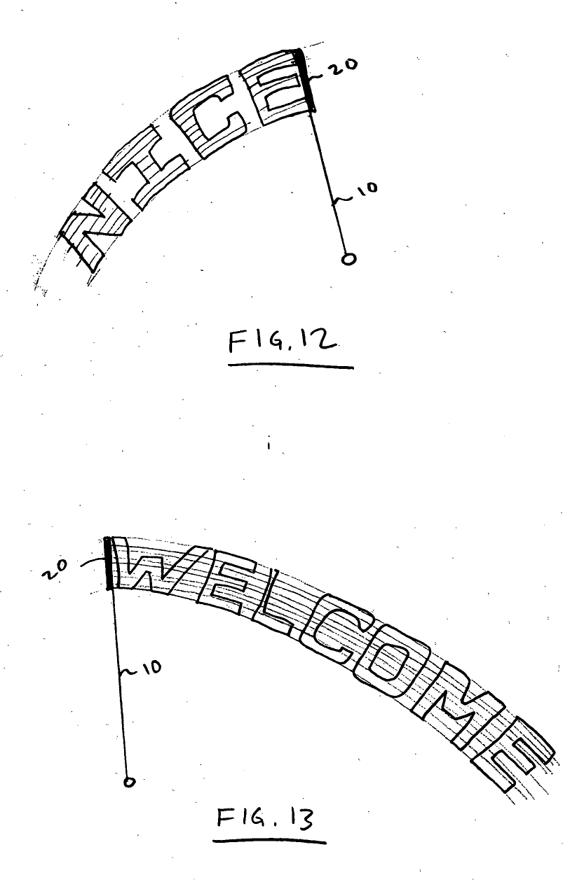

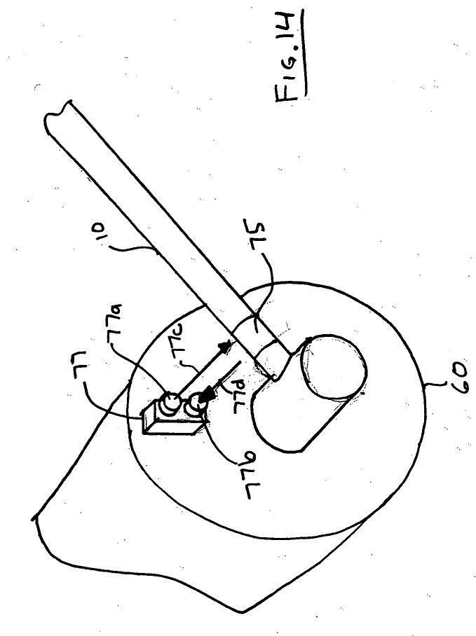

FIGS. 10-13 each respectively show different shapes and symbols displayed using a device made in accordance with the invention. FIG. 10 shows the word “are” displayed using a device made in accordance with the invention. FIG. 11 shows “heart-shaped” symbols being displayed. FIGS. 12 and 13 respectively show the words “nice” and “welcome” displayed using a device made in accordance with the invention.

It will be apparent to those skilled in the art that various modifications and variations can be made in the method and system of the present invention without departing from the spirit or scope of the invention. Thus, it is intended that the present invention include modifications and variations that are within the scope of the appended claims and their equivalents.

1. A device for displaying messages, comprising:
an elongate member having a proximal end and a distal end and defining a longitudinal axis;
a housing having a proximal end and a distal end, the proximal end of the housing coupled to the distal end of the elongate member, the housing including a plurality of light-emitting devices disposed therein, the light emitting devices being oriented along the longitudinal axis;
a power source; and
a processor, the processor operably coupled to the power source and light-emitting devices, wherein the processor is configured to cause the light emitting devices to emit light at predetermined intervals;
wherein the device causes a message to be displayed to an observer when the device is rotated about an axis of rotation at a predetermined rotational velocity.

2. The device of claim 1, wherein the device is configured to display a message at one or more predetermined rotational velocities.

3. The device of claim 2, wherein the device is configured to display a first message at a first rotational velocity, and a second, different message at a second rotational velocity.

4. The device of claim 2, wherein the device is configured to display the same message over a plurality of different rotational velocities.

5. The device of claim 1, further including a velocity detector operably connected to the processor, the velocity detector configured to detect the speed of the device.

6. The device of claim 5, wherein the velocity detector comprises a rotational potentiometer operably coupled to the processor.

7. The device of claim 5, further comprising a hub connected to the proximal end of the elongate member, wherein the velocity detector is located proximate to the hub.

8. The device of claim 5, wherein the velocity detector directly measures the tangential velocity of the device.

9. The device of claim 5, wherein the processor is configured to cause the light emitting elements to emit light in response to a rotational velocity measured using the velocity detector.

10. The device of claim 1, further comprising a handle mounted to the hub.

11. The device of claim 10, wherein the power source is in the handle.

12. The device of claim 1, wherein the device is configured to display a symbol.

13. The device of claim 1, wherein the power source is an electrical generator.

14. The device of claim 13, wherein electrical power is generated by the generator when the device is rotated.

15. The device of claim 14, wherein the generator is configured to measure rotational velocity of device.

16. The device of claim 15, wherein the device is mounted to a wheel of a vehicle.

17. The device of claim 16, wherein the device is mounted to a vehicle used for public transportation, and the device is used to display advertising messages.

18. The device of claim 14, wherein the device is mounted to a fan.

19. A method for displaying messages, comprising:
providing an elongate device, the elongate device having a proximal end, a distal end, and defining a longitudinal direction, the device including a plurality of light emitting devices disposed therein proximate the distal end, the light emitting devices being oriented along the longitudinal axis;
operating a power source and a processor operably coupled to the power source and light-emitting devices to cause the light emitting devices to emit light at predetermined intervals;
rotating the device about an axis of rotation wherein the longitudinal axis defines a radius of a substantially planar viewing plane;
displaying a message to an observer when the device is rotated at a predetermined rotational velocity.

20. A machine readable program containing instructions for controlling a device to display messages, the device having an axis of rotation, an elongate body defining a longitudinal axis, a power source, a processor operably coupled to the power source, and a plurality of light emitting devices operably coupled to the processor and arranged along the longitudinal axis, wherein the program comprises:
means for operating the processor to cause the light emitting devices to display a message to an observer in a substantially planar viewing plane when the device is rotated at a predetermined rotational velocity, the viewing plane defined by rotating the device about the axis of rotation.
